(19) United States
(12) Patent Application Publication
(10) Pub. No.: US 2009/0051140 A1
(43) Pub. Date: Feb. 26, 2009

(54) Fork Protector and Straddle-Type Vehicle Equipped with Fork Protector

(75) Inventor: Hitoshi Saguchi, Shizuoka (JP)

Correspondence Address: HOGAN & HARTSON L.L.P., 1999 AVENUE OF THE STARS, SUITE 1400, LOS ANGELES, CA, 90067, US

(73) Assignee: YAMAHA HATSUDOKI KABUSHIKI KAISHA, Iwata-shi (JP)

(21) Appl. No.: 12/193,890

(22) Filed: Aug. 19, 2008

(30) Foreign Application Priority Data
Aug. 20, 2007 (JP) 2007-214093

(51) Int. Cl. B62J 27/00; B62K 21/02

(52) U.S. Cl. 280/304.3; 280/279

(57) ABSTRACT

A fork protector that inhibits damage to an inverted fork of a straddle-type vehicle. First protector sections cover inner tubes of the inverted fork at front sides of the inner tubes and extend in a length direction of the inner tubes. Second protector sections extend from one end section at a front wheel side of the first protector sections as far as a rear side of the inner tubes.

### RELATED APPLICATIONS

This application claims the benefit of priority under 35 USC 119 of Japanese patent application no. 2007-214093, filed on Aug. 20, 2007, which application is hereby incorporated by reference in its entirety.

### BACKGROUND OF THE INVENTION

1. Field of the Invention

The present invention relates to a fork protector that protects an inverted fork, and a straddle-type vehicle equipped with the fork protector.

2. Description of Related Art

Straddle-type vehicles like motorcycles often use an inverted fork. The inverted fork has an inner tube that extends upward from a wheel axle to which a vehicle wheel is attached, and an outer tube that is connected to an upper section of the inner tube.

In a straddle-type vehicle equipped with an inverted fork, a fork protector may be attached to a front surface and an outer side surface in the vehicle width direction of the inner tube (see, for example, Japanese Utility Model Registration No. 2547045 (page 3, FIG. 1)). The fork protector inhibits the front and outer side surfaces of the inner tube from being damaged by stones or the like that are thrown up from the road surface.

However, even if a fork protector is attached to the inverted fork, there are still occasions when the inner tube is still damaged by stores or the like.

### SUMMARY OF THE INVENTION

The invention addresses these problems and provides a fork protector for a straddle-type vehicle that prevents damage to an inverted fork.

A fork protector according to one aspect of the invention is attached to an inverted fork including an inner tube that extends upward from a wheel axle to which a vehicle wheel of a straddle-type vehicle is attached, and an outer tube that is connected to an upper section of the inner tube. The fork protector includes a first protector section that covers the inner tube at a front side of the inner tube and that extends in a length direction of the inner tube, and a second protector section that extends from one end section in a vehicle width direction of the first protector section as far as a rear side of the inner tube.

The invention thus provides a fork protector that prevents damage to an inverted fork of a straddle-type vehicle.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a left side view of a motorcycle according to an embodiment of the invention.

FIG. 2 is a diagram of a fork protector 61 according to the embodiment of the invention.

FIG. 3 is a diagram of a fork protector 62 according to the embodiment of the invention.

FIG. 4 is a view of a part of the motorcycle along the direction of arrow F1 of FIG. 1.

FIG. 5 is an enlarged view of a left side surface of the motorcycle according to the embodiment of the invention.

FIG. 6 is a cross sectional view taken along line C-C of FIG. 5.

FIG. 7 is an explanatory view showing movement of a stone thrown up by a front wheel in the cross sectional view taken along line C-C of FIG. 5.

FIG. 8 is an enlarged view of a left side surface of a motorcycle according to another embodiment of the invention.

### DETAILED DESCRIPTION OF THE INVENTION

An embodiment of a straddle-type vehicle according to the invention is now described with reference to the drawings. In the following drawings, structural members that are the same or similar are denoted with the same or similar reference numerals. The drawings are schematic, and thus the relative scale of dimensions and the like may be different from those of the real object.

Specific dimensions and the like can be determined based on reference to the following description. In addition, it will be readily apparent that the drawing figures include sections in which the relationship and scale of respective dimensions etc. are different.

(1) Overall Structure of the Straddle-Type Vehicle

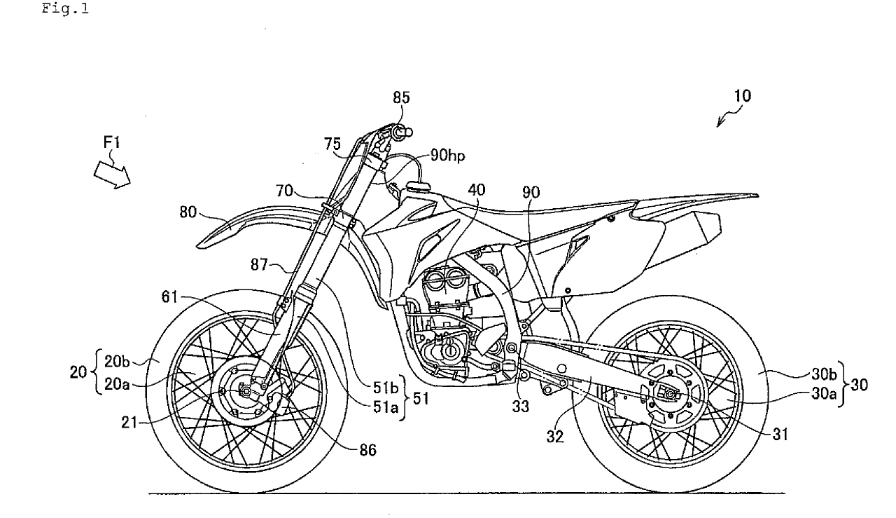

FIG. 1 is a left side view of a motorcycle 10 that is a straddle-type vehicle according to an embodiment of the invention. As shown in FIG. 1, motorcycle 10 is suitable for driving along an uneven road and includes a front wheel 20 and a rear wheel 30. An engine 40 generates driving force that drives rear wheel 30.

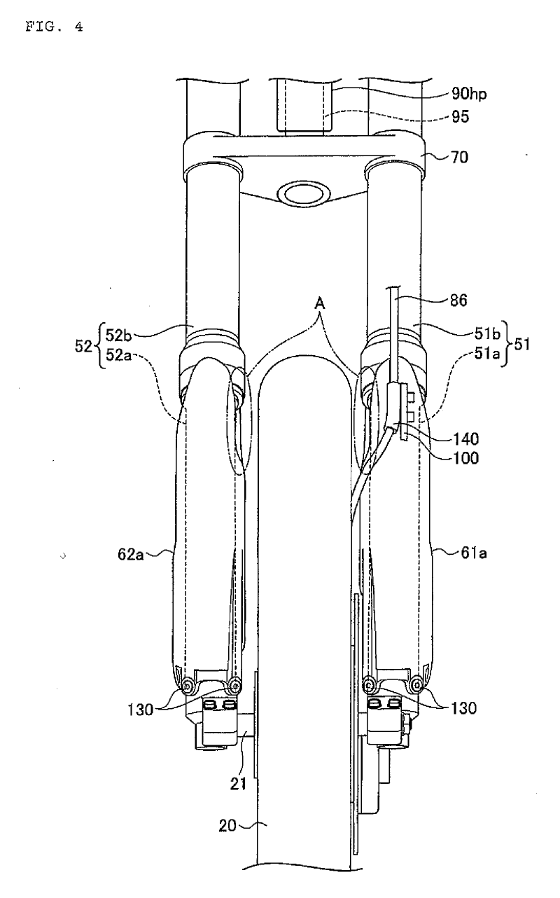

Front wheel 20 has a wheel 20a that is rotatably supported by a wheel axle 21, and a tire 20b that is attached to an outer periphery of wheel 20a. A left and right pair of front forks 51, 52 are attached to both end sections in the vehicle width direction of wheel axle 21 (front fork 52 is not shown in FIG. 1; refer to FIG. 4).

Front forks 51, 52 move front wheel 20 linearly upward and downward (more precisely, in a direction with a determined caster angle) in accordance with changes in a road surface condition such that shock received by front wheel 20 is absorbed.

As can be seen from FIG. 1, front forks 51, 52 include inner tubes 51a, 52a that extend upward from wheel axle 21, and outer tubes 51b, 52b in which inner tubes 51a, 52a are inserted. More particularly, front forks 51, 52 of this embodiment are inverted front forks.

Inner tubes 51a, 52a and outer tubes 51b, 52b are both formed with a cylindrical shape. Inner tubes 51a, 52a slidably move within outer tubes 51b, 52b. A seal is provided at the inside of the lower end of each of outer tubes 51b, 52b.

Fork protectors 61, 62 that inhibit inner tubes 51a, 52a from being damaged are attached to inner tubes 51a, 52a. The structure of fork protectors 61, 62 is now explained.

Up-down direction center sections of outer tubes 51b, 52b are connected by an under bracket 70. A front fender 80 is attached to a vehicle width direction center section of under bracket 70. Front fender 80 extends around an outer periphery of tire 20b at the upper side of front wheel 20.

Upper end sections of outer tubes 51b, 52b are connected by an upper bracket 75. A steering handle 85 that is operated by the rider to change the direction of orientation of the vehicle body is attached to upper bracket 75. A brake hose 87 runs from steering handle 85 toward a brake caliper 86.

A body frame 90 forms the frame of motorcycle 10. A head pipe 90hp is formed at the front end of body frame 90. A steering shaft 95 (FIG. 4) is turnably supported by head pipe 90hp.

Rear wheel 30 includes a wheel 30a that is turnably supported by a wheel axle 31, and a tire 30b that is attached to the outer periphery of wheel 30a. Wheel axle 31 is attached to a rear end section of a rear arm 32. Rear arm 32 is swingably attached to a pivot shaft 33.

(2) Structure of the Fork Protectors

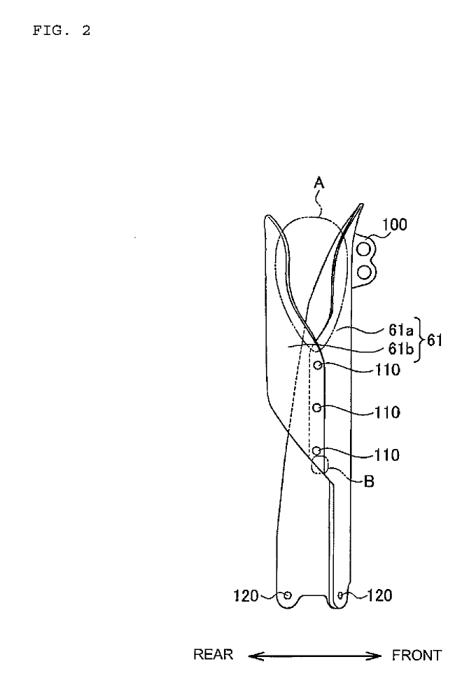

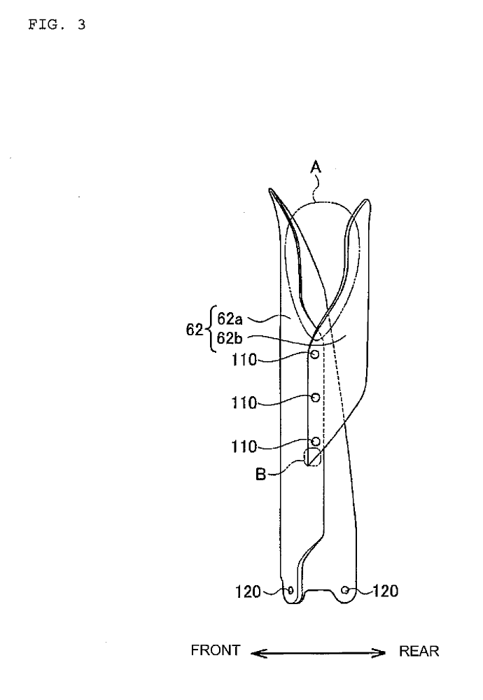

The structure of fork protectors 61, 62 is explained with reference to FIGS. 2 and 3. FIG. 2 is a unit diagram of fork protector 61. FIG. 3 is a unit diagram of fork protector 62.

As shown in FIGS. 2 and 3, fork protectors 61, 62 are formed to generally have left-right symmetry. As can be seen from FIG. 2, fork protector 61 has a stay attachment member 100 that attaches a stay for fixing brake hose 87.

Fork protectors 61, 62 have first protector sections 61a, 62a and second protector sections 61b, 62b connected by a rivet 110. More particularly, second protector sections 61b, 62b are connected at an upward-downward direction center section of one end section of first protector sections 61a, 62a. When fork protectors 61, 62 are attached to motorcycle 10, the connection section of first protector sections 61a, 62a and second protector sections 61b, 62b is located at the inside in the vehicle width direction.

A notch A is formed in an upper end section of each of fork protectors 61, 62. Round holes 120 are formed in lower end sections of first protector sections 61a, 62a. Round holes 120 are used to attach fork protectors 61, 62 to motorcycle 10. In addition, lower end sections B of second protector sections 61b, 62b are formed with an acute angle.

(3) Attachment State of the Fork Protectors

The attachment state of fork protectors 61, 62 is explained with reference to FIGS. 4-6. The following explanation mainly focuses on the structure of the left side of motorcycle 10. The right side has a structure that is substantially the same as that of the left side and thus is omitted as appropriate.

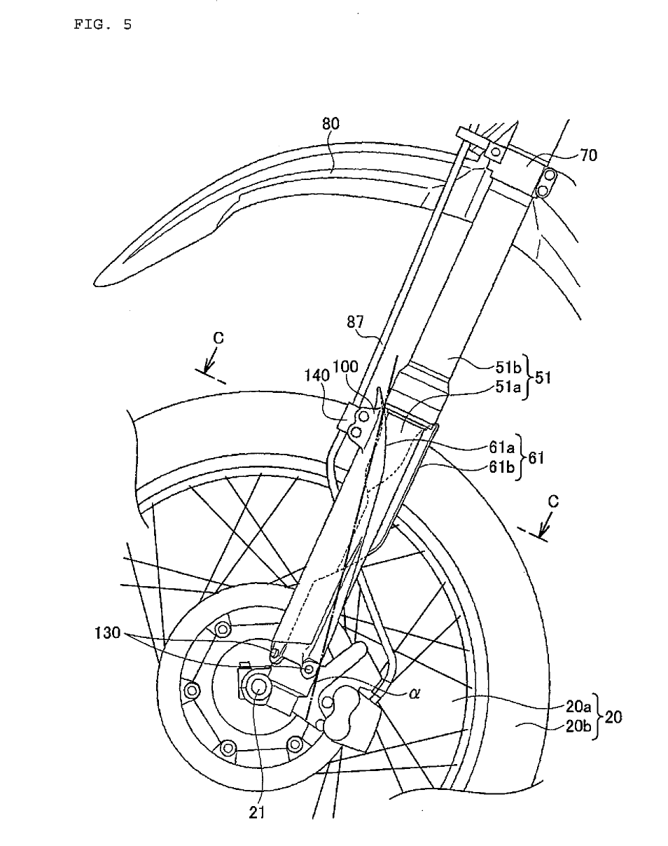

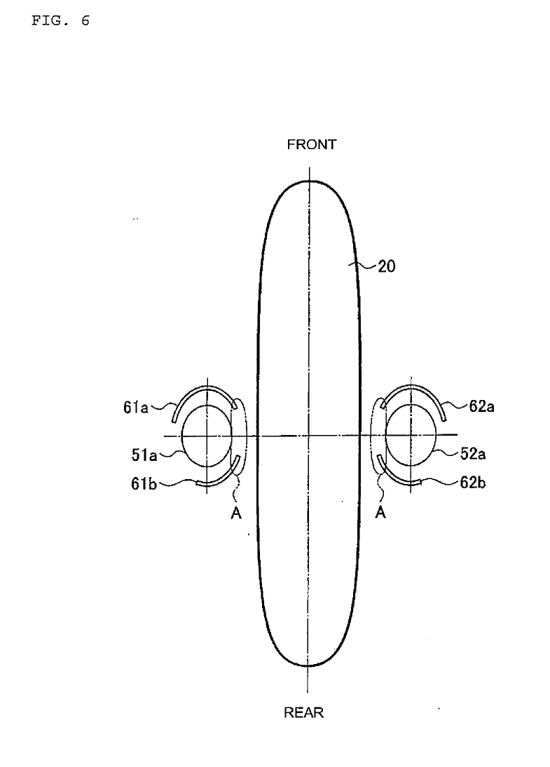

FIG. 4 is a view along the direction of arrow F1 of FIG. 1. FIG. 5 is an enlarged left side view of motorcycle 10. FIG. 6 is a cross sectional view along line C-C of FIG. 5. In FIG. 4, in order to make the structure of fork protectors 61, 62 clearer, front fender 80 is omitted.

As shown in FIG. 4, lower end sections of inner tubes 51a, 52a are attached to vehicle width direction end sections of wheel axle 21. Inner tubes 51a, 52a extend upward from wheel axle 21. Inner tubes 51a, 52a are inserted inside outer tubes 51b, 52b. As can be seen from FIG. 5, a seal 150 is provided at the inside of the lower end of each of outer tubes 51b, 52b.

Outer tubes 51b, 52b are connected by under bracket 70. Steering shaft 95 extends upright from a vehicle width direction center section of under bracket 70. Steering shaft 95 is supported by head pipe 90hp such that steering shaft 95 can turn centering on a central axis of steering shaft 95.

Fork protectors 61, 62 are fixed to the lower end sections of inner tubes 51a, 52a by inserting bolts 130 through round holes 120 formed in the lower end sections of first protector sections 61a, 62a.

A stay 140 that fixes brake hose 87 is attached to stay attachment member 100 of fork protector 61.

As shown in FIGS. 4 and 5, first protector section 61a covers inner tube 51a at the front side of inner tube 51a. More particularly, first protector section 61a is positioned to the front side of inner tube 51a and extends in the length direction of inner tube 51a. First protector section 61a is formed to match the outer surface of inner tube 51a that is formed with a cylindrical shape.

In addition, first protector section 61a, as shown in FIG. 5, extends toward the outside in the vehicle width direction of inner tube 51a. More particularly, first protector section 61a covers, within the surface at the outside in the vehicle width direction of inner tube 51a, an area forward of a line α that connects a lower end rear section of inner tube 51a and a lower end front section of outer tube 51b.

Second protector section 61b is connected to one end section at the inside in the vehicle width direction of first protector section 61a by rivet 110. Second protector section 61b is formed to match the outer surface of inner tube 51a that is formed with a cylindrical shape.

Second protector section 61b is positioned further upward than a center section in the length direction of inner tube 51a. Furthermore, second protector section 61b is positioned further upward than the lower end section of inner tube 51a. Thus, a rear section of the lower end of inner tube 51a is not covered by second protector section 61b, and is exposed to the outside.

As shown in FIG. 5, front wheel 20 includes wheel 20a that is turnably supported by wheel axle 21, and tire 20b that is attached to the outer periphery of wheel 20a. The upper end sections of inner tube 51a and second protector section 61b overlap with tire 20b in a side view of motorcycle 10. In other words, the upper end sections of inner tube 51a and second protector section 61b are positioned to the outside of the outer periphery of tire 20b.

Second protector section 61b extends from one end section at the front wheel 20 side of first protector section 61a to the rear of inner tube 51a. More particularly, as shown in FIG. 6, second protector section 61b extends, within the rear surface of inner tube 51a, as far as a vehicle width direction center section.

As shown in FIG. 6, a notch A is formed in the upper end section of each of fork protectors 61, 62 between front forks 51, 52 and front wheel 20.

(Operation and Advantages)

In the known art, even though the fork protector is attached to the front surface and the vehicle width direction outer side surface of the inner tube, the inner tube may still be damaged.

The inventor observed that this damage of the inner tube is caused by stones or the like thrown up by rotation of the vehicle wheels. In addition, the inventor identified that a large proportion of the damage of the rear surface of the inner tube occurs at the position where the inner tube overlaps with the vehicle wheel when the vehicle body is seen from the side.

To address this, fork protectors 61, 62 of the embodiment are provided with first protector sections 61a, 62a and second protector sections 61b, 62b. First protector sections 61a, 62a cover inner tubes 51a, 52a at the front side of inner tubes 51a, 52a, and extend in the length direction of inner tubes 51a, 52a. Second protector sections 61b, 62b extend from the one end section at front wheel 20 side of first protector sections 61a, 62a to the rear side of inner tubes 51a, 52a.

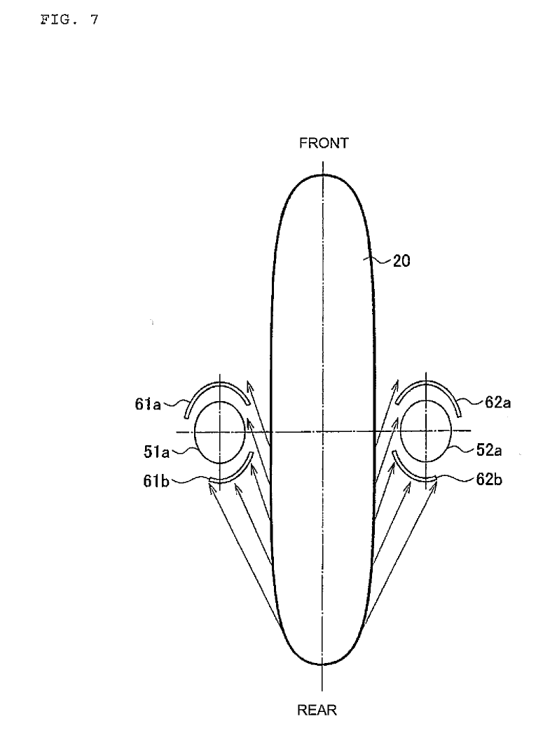

As a result, as shown in FIG. 7, stones etc. that are thrown up by rotation of front wheel 20 and fly toward inner tubes 51a, 52a from the vehicle body rear direction are knocked away by second protector sections 61b, 62b. Thus, damage to the rear surfaces of inner tubes 51a, 52a is inhibited.

Moreover, stones etc. that are thrown up by vehicles running in front and fly toward inner tubes 51a, 52a from the vehicle body front direction are knocked away by first protector sections 61a, 62a. Thus, damage to the front surfaces of inner tubes 51a, 52a is inhibited.

In this manner, fork protectors 61, 62 according to the invention inhibit damage to the inverted fork. As a result, the durable life of front forks 51, 52 is lengthened, and the physical effort and expense required for replacing the front forks is reduced.

In addition, second protector sections 61b, 62b according to the embodiment, when viewed from the side of the vehicle, overlap with tire 20b. Thus, second protector sections 61b, 62b effectively protect the area within the rear surface of inner tubes 51a, 52a that is most easily damaged.

Furthermore, second protector sections 61b, 62b according to the embodiment are positioned to the upper side of the center sections in the length direction of inner tubes 51a, 52a. Accordingly, the sections that frequently slide within outer tubes 51b, 52b of inner tubes 51a, 52a are effectively protected. Thus, damage to seal 150 as a result of damage to inner tubes 51a, 52a is inhibited.

Furthermore, second protector sections 61b, 62b according to the embodiment are positioned to the upper side of the lower end sections of inner tubes 51a, 52a. In this manner, the lower end sections of inner tubes 51a, 52a are not covered by second protector sections 61b, 62b. Thus, dirt and sand that enter into the gap between inner tubes 51a, 52a and fork protectors 61, 62 can easily escape.

In addition, second protector sections 61b, 62b according to the embodiment extend from the one end section at the front wheel 20 side of first protector sections 61a, 62a as far as the rear of inner tubes 51a, 52a. Accordingly, as shown in FIG. 7, the vehicle width direction inner side sections of the rear surfaces of inner tubes 51a, 52a are reliably protected.

In addition, second protector sections 61b, 62b according to the embodiment extend as far as the vehicle width direction center sections of the rear surfaces of inner tubes 51a, 52a. As a result, as shown in FIG. 7, the vehicle width direction outer side sections of the rear surface of inner tubes 51a, 52a are reliably protected.

Moreover, the upper end sections of fork protectors 61, 62 according to the embodiment are provided with notch A between front forks 51, 52 and front wheel 20. As a result, when under bracket 70 and front fender 80 move downwards, interference of under bracket 70 and front fender 80 with fork protectors 61, 62 is avoided.

Moreover, lower end sections B of second protector sections 61b, 62b according to the embodiment are formed with an acute angle. Thus, as compared to a case where the lower end sections of second protector sections 61b, 62b are formed in a rectangular shape, the manufacturing cost and weight of second protector sections 61b, 62b are reduced.

In addition, first protector sections 61a, 62a and second protector sections 61b, 62b according to the embodiment extend along the outer surfaces of inner tubes 51a, 52a. As a result, inner tubes 51a, 52a are disposed in a compact manner.

### Other Embodiments

One embodiment of the invention has been described to disclose the features of the invention. However, the invention is not limited by this description and various modified forms are within the scope of the invention.

For example, fork protectors 61, 62 are described as attached to front forks 51, 52. However, if a rear fork is connected to rear wheel 30, fork protectors 61, 62 may be attached to the rear fork.

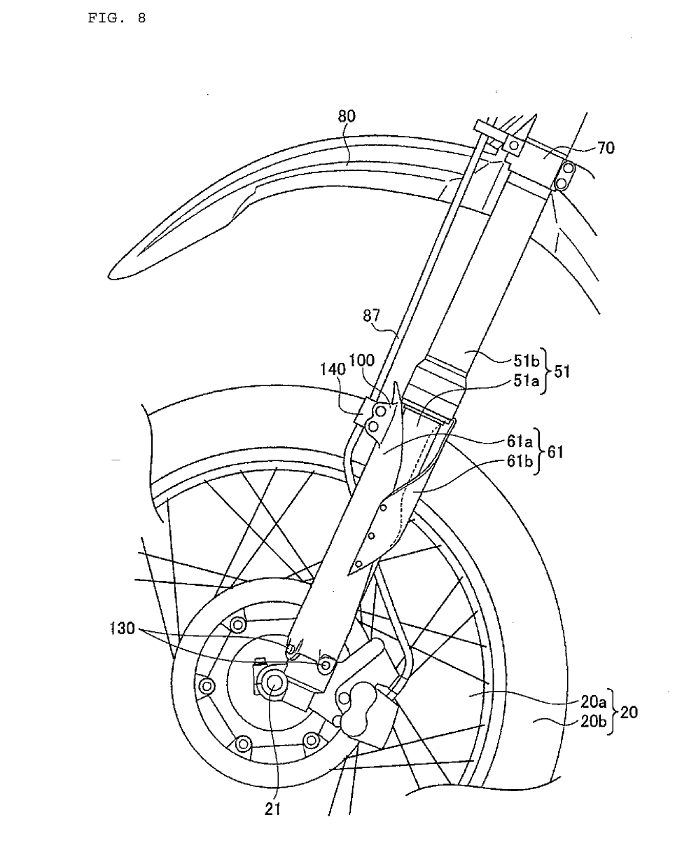

Moreover, in the above-described embodiment, second protector sections 61b, 62b are connected to the one end section of first protector sections 61a, 62a at the front wheel 20 side. However, as shown in FIG. 8, second protector sections 61b, 62b may be connected to one end section at the vehicle width direction outer side of first protector sections 61a, 62a.

Moreover, in the above-described embodiment, notch A is formed in first protector sections 61a, 62a and second protector sections 61b, 62b. However, notch A may be formed in either one of the members.

Moreover, in the above-described embodiment, first protector sections 61a, 62a and second protector sections 61b, 62b are formed as separate members, but they may be integrated.

As will be readily apparent, the invention includes these and various other modified embodiments that are not specifically described herein. The scope of the invention is defined by the following claims.

1. A fork protector attached to an inverted fork including an inner tube that extends upward from a wheel axle to which a vehicle wheel of a straddle-type vehicle is attached, and an outer tube that is connected to an upper section of the inner tube, the fork protector comprising:
a first protector section that covers the inner tube at a front side of the inner tube and that extends in a length direction of the inner tube; and
a second protector section that extends from one end section in a vehicle width direction of the first protector section as far as a rear side of the inner tube.

2. The fork protector according to claim 1, wherein
the vehicle wheel includes a wheel that is rotatably supported by the wheel axle, and a tire that is attached to an outer periphery of the wheel, and
the second protector section overlaps with the tire when viewed from a side of the vehicle.

3. The fork protector according to claim 1, wherein the second protector section is positioned to an upper side of a center section in the length direction of the inner tube.

4. The fork protector according to claim 1, wherein the second protector section is positioned to an upper side of a lower end section of the inner tube.

5. The fork protector according to claim 1, wherein the second protector section extends from one end section at the vehicle wheel side of the first protector section as far as the rear side of the inner tube.

6. The fork protector according to claim 5, wherein the second protector section extends as far as a vehicle width direction center section of a rear surface of the inner tube.

7. The fork protector according to claim 1, further comprising
a steering shaft, and an under bracket that supports a lower end of the steering shaft, wherein
at least one of upper end sections of the first protector section and the second protector section are provided with a notch between the fork and the vehicle wheel.

8. The fork protector according to claim 1, wherein a lower end section of the second protector section is slanted to face toward a front and lower part of the vehicle.

9. The fork protector according to claim 1, wherein the first protector section and the second protector section extend along an outer surface of the inner tube.

10. A straddle-type vehicle comprising:
a wheel axle to which a vehicle wheel is attached;
an inverted fork having an inner tube that extends upward from the wheel axle, and an outer tube that is connected to an upper section of the inner tube; and
a fork protector that includes:
a first protector section that covers the inner tube at a front side of the inner tube and that extends in a length direction of the inner tube; and
a second protector section that extends from one end section in a vehicle width direction of the first protector section as far as a rear side of the inner tube.

11. A straddle-type vehicle comprising the fork protector of claim 2.
